(19) United States
(12) Patent Application Publication
(10) Pub. No.: US 2017/0213243 A1
(43) Pub. Date: Jul. 27, 2017

(54) MEDIA CONTENT ADVERTISEMENT SYSTEM BASED ON A RANKING OF A SEGMENT OF THE MEDIA CONTENT AND USER INTEREST

(71) Applicant: Morgan Francois Stephan Dollard, Belmont, CA (US)

(72) Inventor: Morgan Francois Stephan Dollard, Belmont, CA (US)

(73) Assignee: GOOGLE INC., Mountain View, CA (US)

(21) Appl. No.: 13/342,518

(22) Filed: Jan. 3, 2012

(51) Int. Cl. G06Q 30/02

(52) U.S. Cl. CPC G06Q 30/0249

(57) ABSTRACT

Systems and methods for matching advertising to segments of media content based at least in part on rank and user interest are disclosed herein. In an aspect, the media content segments can be ranked based at least in part on the user interest. Further, respective segments of the media content can be classified based at least in part on user interest. In an aspect, advertisements can be matched to the ranked segments of the media content. In another aspect, the matching can be based on similarity between context or content of the media segment and a product or service associated with the advertisement.

### TECHNICAL FIELD

This disclosure relates to advertising associated with subsets of media content based at least in part on rank and user interest.

### BACKGROUND

Media consumers often consume content at a variable point in media content other than at a beginning point or end point. Advertising is often embedded at the beginning data point of media content or at the end data point of media content. As the media consumer jumps around at variable data points of particular media content, the consumer may skip over advertisements and fail to view, consume, and form impressions in connection with those advertisements.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with ranking and/or classifying media content based on user interest and associating advertising with ranked and/or classified segments of media content.

In accordance with a non-limiting embodiment, in an aspect, a system is provided comprising a memory having stored thereon computer executable components, and a processor configured to execute the computer executable components stored in the memory. A monitoring component monitors user interest in segments of media content; and a rank component ranks respective segments of the media content based at least in part on user interest. A classifying component classifies respective segments of media based at least in part on user interest; and an advertising component matches respective advertisements to the ranked segments of the media content.

In various aspects, the advertising component matches an advertisement to a media segment based at least in part on similarity between content or context of the media segment and/or a product or service associated with the advertisement. In another aspect, the advertising component matches an advertisement to a media segment based at least in part on demographics of users that deem the media segment popular. The system can further comprise a pricing component that prices advertisement slots associated with respectively ranked media segments based at least in part on the ranking. Further, the system can comprise an auction component that sets and receives bids for advertising slots associated with the ranked segments.

The disclosure further describes a method, comprising using a processor to execute computer executable instructions stored in a memory to perform the various acts. User interest in segments of media content is monitored. Respective segments of the media content are ranked based at least in part on user interest. Respective segments of media are classified based at least in part on user interest; and respective advertisements are matched to the ranked segments of the media content. In an aspect, the method can comprise predicting traffic flow associated with future streaming of media segments, and/or setting pricing for the advertising slots based at least in part on the predicted traffic flow.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting system for matching advertisements to segments of media.

FIG. 2 illustrates an example non-limiting system that prices advertisement slots associated with ranked media segments.

FIG. 3 illustrates an example non-limiting system that matches an advertisement to a media segment based at least in part on ranking.

FIG. 4 illustrates an example non-limiting system that launches an advertisement.

FIG. 5 illustrates an example non-limiting system that predicts when future demand for a segment of media content will level off or decline

FIG. 6 illustrates an example non-limiting system that analyzes traffic patterns for media segments that auction

FIG. 7 illustrates an example non-limiting system that sets and receives bids for advertising slots associated with the ranked segments.

FIG. 8a illustrates an example methodology for monitoring, ranking, caching and transmitting media content segments.

FIG. 8b illustrates an example methodology for monitoring, ranking, classifying, and matching media content segments.

FIG. 8c illustrates an example methodology for monitoring, ranking, classifying, matching, and pricing media content segments.

FIG. 8d illustrates an example methodology for monitoring, ranking, classifying, matching, pricing, and predicting demand relating to media content segments.

FIG. 8e illustrates an example methodology for monitoring, ranking, classifying, matching, pricing, predicting demand, and setting and receiving bids related to media content segments.

FIG. 9 is a block diagram representing an exemplary non-limiting networked environment in which the various embodiments can be implemented.

FIG. 10 is a block diagram representing an exemplary non-limiting computing system or operating environment in which the various embodiments may be implemented.

### DETAILED DESCRIPTION

### Overview

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter disclosed in this disclosure relates to associating advertisements with segments of media content that respectively are of greater interest to content consumers than other sections of the media content. To facilitate effective advertising, embodiments described in this disclosure provide for monitoring content, viewing traffic associated with respective content as well as content consumer interest in specific sections of content. By identifying, ranking, and classifying sections of content that are of particular interest to content consumers, such sections can be matched to advertisements, auctioned to advertisers, and priced based on advertiser demand as well as predicted traffic flow.

For example, if a segment 1:15:01 to 1:32:00 of a two-hour video was very popular to viewers, and an advertiser knew that the segment received a significant quantity of traffic from viewers between the ages of 21 and 30, the advertiser could match an advertisement at a data point within that segment to cater to the viewer age demographic. In accordance with embodiments described in this disclosure, such highly ranked (or popular) segment of the video can be priced and auctioned to purchasers of advertisement slots. Such feature can enhance efficacy of advertising (e.g. advertisement matches content of media segment), optimize pricing of advertisements (e.g. price based on demand), and enhance content consumer experience (e.g. user views an advertisement of interest).

### Example Media Content System Based on a Ranking and Classification of a Segment of the Media Content and User Interest

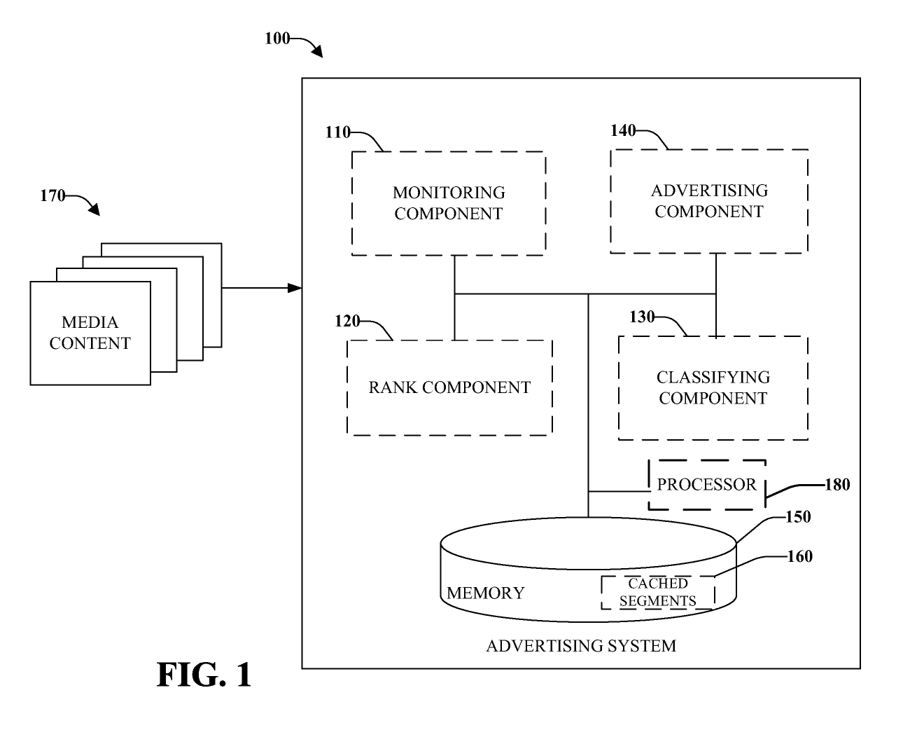

Referring now to the drawings, with reference initially to FIG. 1, system 100 is shown that facilitates matching advertisements to segments of media content based on ranking of one or more segments of the media content and user interest. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), virtual machine(s), etc. can cause the machine(s) to perform the operations described. System 100 can include memory 102 for storing computer executable components and instructions. A processor 104 can facilitate operation of the computer executable components and instructions by the system 100.

In an embodiment, system 100 employs a monitoring component 110, a rank component 120, a classifying component 130, and an advertising component 140. In an aspect, the monitoring component 110 monitors content consumer interests in respective segments of media content 170 (e.g., videos, audio, . . . ). Rank component 120 ranks respective segments of the media content 170 based at least in part on user interest, classifying component 130 classifies respective segments of the media content based at least in part on user interest, and advertising component 140 matches respective advertisements to the ranked segments of the media content.

Media content 170 can include media data associated with one or more data sources (not shown) that can be accessed by a system such as system 100 (and additional systems described in this disclosure) or a client device (not shown). For example, a data source can include a data store storing media content and affiliated with a content provider that interacts with the system 100. In another aspect, a data source can include a data store that stores media content remote from a content provider or a system 100. In an aspect, media content 170 can include media data as media items. For example, the media content 170 can include one or more media items (e.g., video and/or audio including but not limited to movies, television, streaming television, video games, or music tracks).

A client device can include any suitable client device associated with a user and configured to interact with or receive media content (e.g. segments of media content matched to advertisements). For example, a client device can include a desktop computer, a laptop computer, a smart-phone, a tablet personal computer (PC), or a PDA. As used in this disclosure, the terms “content consumer” or “user” refer to a person, entity, system, or combination thereof that employ system 100 (or additional systems described in this disclosure). In an aspect, a client device or system 100 (or additional systems described in this disclosure) can be configured to access the media content 170 via a network such as for example the Internet, intranet, or cellular service.

Further, media content 170 can include media data distributed by another system or device (not shown) that interacts with the system 100. For example, system 100 could receive media content 170 from a system that monitors user interest in sections of media content; ranks respective sections of the media content based at least in part on the user interest; caches respective sections of the media content based at least in part on the ranking; and transmits a subset of the cached media content sections. Media content 170 can include any such monitored, ranked, and/or cached sections of the media content of a content distribution system.

According to an embodiment, monitoring component 110 monitors interaction with the media content 170 to identify content consumer interest in respective segments thereof. As used in this description, a segment of media content refers to a section of media content of a media item that is a subset of the media item. For example, a media item can include two hours of video and a segment of the media item can be referenced for example by time 1:30:01 to 1:41:00. In another aspect, a segment of the media item can be referenced by a set of media frames. For example, a media item can include M frames (M is an integer). According to this example, a segment of media content of the media item could include for example frames 1-57, or frames 7008-8001.

Further, as used in this disclosure, content consumer interest in media content refers to one or more users' affinity for a segment of media content. For example, users may have an affinity for a segment of media content based on appearance of a famous actor in the segment. In another example, users may have an affinity for a segment of media content based on occurrence of a climactic event at the particular segment of the media content. In an aspect, when a large set of users have common affinity for a segment of media content as compared to other segments, popularity of the segment can be deemed greater that the other segments of the media content. For example, when multiple users repeatedly have an interest in a same or similar segment of media content, user interest in the section of the media item can relate to collective content consumer affinity for the section. Furthermore, in an aspect user interest can be based in part on the ability of a user to replay and/or rewind a segment of media content.

In an embodiment, monitoring component 110 monitors content consumer interest in segments of media content based at least in part on content consumer traffic associated with respective segments of the media content. In an aspect, monitoring component 110 can determine user interest in a media item based on user interaction (e.g., fast forwarding to certain segments, time spent viewing certain sections, references to certain segments . . . ) with the media item. Any suitable type of information that can facilitate gleaning, determining, or inferring content consumer interest in respective media content segments can be utilized by the monitoring component 110 or rank component 120. More particularly, user interaction with segments of media content can include but is not limited to, viewing a segment of a media content, controlling playing of a segment of media content, bookmarking a segment of media content, referencing a segment of media content, communicating a segment of media content, posting or storing a segment of media content, tagging or bookmarking a segment of media content. For example, the monitoring component 110 can monitor the number of views or the number of different user views of a segment of media content.

The monitoring component 110 can also identify a segment of media content as popular based on number of views. For example, the monitoring component may determine that 85% of users of a media item are interested in a segment starting at 0:53:02 to 1:21:39. In another example, the monitoring component 110 can monitor time spent monitoring a section of media content. In an aspect, controlling a segment of media content can include but is not limited to fast-forwarding to a segment of media content, rewinding to a segment of media content, replaying a segment of media content, pausing at a segment of media content, or editing a segment of media content.

In yet another aspect, monitoring component 110 can monitor or employ extrinsic information in conjunction with monitoring user interaction with segments of media content. For example, extrinsic information can include but is not limited to, world wide web (web) postings associated with segments of media content, clippings of segments of media content, or web links associated with the segments of the media content, user queries associated with the media content. According to this aspect, extrinsic information can be employed by monitoring component 110 or rank component 120 to determine or infer content consumer interest in segments of the media content 170. For example, multiple views of a particular segment of media content accompanied by postings of links to the particular segment of the media content and multiple search queries for the particular segment of the media content can be employed as a measure of content consumer interest in the particular segment of the media content.

In an embodiment, in addition to monitoring content consumer interest in respective segments of media content, monitoring component 110 can monitor characteristics of the respective segments of the media content. In an aspect, a characteristic of the segment of the media content can include tags embedded in the media content. A tag can include metadata that identifies a data point or a segment of the media content. In an aspect, the tag can identify a data point or segment of media content as having a distinguishing characteristic (e.g., person, object, location, audio, scene, and event). The tags, for example, can be user generated, computer generated or social network generated. In an aspect of user generated tags, tags can refer to information gathered from user interaction with the media content. The user interaction can be any number of traceable acts such as bookmarks, user queries, content published by user, user comments on content, user creation of content (e.g., uploading a video to a video distribution site), user created value-add content to existing content. Furthermore, other extrinsic sources that can be employed in connection with assessing popularity of respective media segments can include but are not limited to: communication content technologies, published media content, problem processing content applications, news content, gossip content, research content, digital media content technologies, questions-answer databases, digital video content, blogged content, podcast content, content forums, or review-website content.

Additionally, in an embodiment, monitoring component 110 monitors traffic and can predict quantity of future traffic associated with respective segments of media content. For example, monitoring component 110 may monitor time-varying characteristics relating to “advertising traffic” for a particular segment of content. For example, monitoring component 110 can monitor one or a combination of the following factors: (1) the extent to and rate at which advertisements are presented or updated by a given segment of media content over time; (2) the quality of the advertisers (e.g., a segment of content whose advertisements refer/link to documents known to analysis component 606 over time to have relatively high traffic and trust may be given relatively more weight than those segment of media content whose advertisements refer to low traffic/untrustworthy documents, such as a adult content site); and (3) the extent to which the segment of content generate user traffic to the advertisement which they relate (e.g., their click-through rate).

In another aspect, monitoring component 110 predicts quantities of future traffic associated with respective segments of media content based on any one or more of the above advertising traffic characteristics as well as factors such as total number of monthly views, total number of unique monthly users, total number of impressions where one advertisement view is one impression (e.g. if a segment of content contains four advertisements there will be four impressions per segment of content view), number of fraudulent clicks, click-through rate (e.g. number of clicks on an advertisement divided by number of impressions), display time of advertisement, and other such factors. Further, based on any of the above identified elements, the monitoring component 110 or rank component 120 can identify segments of media where characteristics of the media segments drive content consumer traffic thereto. For example, advanced digital effects relating to a popular movie can be identified as a characteristic that is driving content consumer interest to the respective media segment. In an embodiment, rank component 120 can be employed to rank respective segments of the media content 170 based at least in part on content consumer interest.

In an embodiment, the rank component 120 can be configured to rank a segment of media content based at least in part on user interest in that segment. In an aspect, ranking based at least in part on user interest can apply a priority scheme relating to recommended respective content segments of a media item. For example, for a media item, the rank component 120 can rank a user's interest in one segment as higher than another. In another aspect, the rank component 120 can rank content consumer interest in a segment of media content against one or more segments of media content from the same or different media items. For example, the rank component 120 can rank a first set of media content segment frames of a first media item higher or lower than a second set of content segment frames of a second media item. In yet another aspect, rankings can be multi-tiered. For instance, a segment of media content can be ranked against other segments as well as against segments of another media item based at least in part on viewing traffic. The rank component 120 can rank media segments based at least in part on a set of users, a subset of users, user preference, user historical preferences, user feedback, number of views, number of references, etc. Respective advertisements can be placed and/or priced in accordance with the rankings.

In an embodiment, system 100 further comprises a classifying component 130. Classifying component 130 can be employed to classify respective segments of the media content 170 and/or advertisements to be placed or priced based at least in part on content consumer interest. The classifying component 130 can be configured to classify a segment of media content and/or advertisements to be placed or priced based at least in part on user interest in that segment. In an aspect, classification based at least in part on user interest can apply a categorization scheme relating to respective content segments of a media item. For example, for a media item, the classifying component 130 can classify a user's interest in one segment and/or advertisement within a category different from a user's interest in another segment (e.g. categorize a movie segment as drama and another segment from the same movie as action). In another aspect, the classifying component 130 can classify content consumer interest in a segment of media content and/or advertisement against one or more segments of media content and/or advertisements from the same or different media items. For example, the classifying component 130 can classify a first set of media content segment frames of a first media item within a different category than a second set of content segment frames of a second media item.

In an embodiment, classifying component 130 can classify media content and/or advertisements to be placed or priced into genres or categories. Classifying component 130 may use the predetermined label categories to associate a genre with media content. For example, classifying component 130 may extract a title, words from the title, or other meta-data words associated with media content (e.g., videos, audio). The extracted words or identifiers may be associated with categories or genres in the predetermined label categories. Further, classifying component 130 can retrieve the associated segment of content from the predetermined label categories using extracted identifiers. In an example, any movie title or segment of content tagged with the words “Christmas,” “Thanksgiving,” and “Easter” are classified into a movie category labeled “holiday movies.”

In an aspect, classifying component 130 can classify media content and/or advertisements to be placed or priced based on external information such as users social network labels (e.g. predetermined classifications labels). For example, classifying component 130 can use text analysis to determine classification labels to associate with user nodes in a generated social graph. The subject of the analysis can include media content and/or advertisements associated with user profiles, comments posted by a user (e.g. comments on a youtube video posted to user facebook account), descriptions of groups to which a user belongs, etc. In an aspect, predetermined classification labels for media content and/or advertisements can be based on keywords, which can be submitted by advertisers and/or users. For example, the keywords can include the term “furniture.” This can be used as a predetermined classification label, which classifying component 130 associates with media content and/or advertisements to be placed or priced that include the term “furniture.” Additionally, classifying component 130 can classify media content and/or advertisements with associations to a label. For instance, classifying component 130 can classify under the label “furniture” advertisements that include words associated with “furniture,” such as chair, table, or home decorating.

Classifying component 130 in connection with rank component 120 can also rank classified segments of media content and/or advertisements to be placed or priced based at least in part on content user interest. For instance, classifying component 130 can classify a group of segments of media content and rank component 120 can rank a segments of media content within the category based at least in part on user interest in that segment. In an aspect, classifying component 130 can classify, based at least in part on rankings from rank component 120, categorized segments of media content and/or advertisements based at least in part on user interest and can apply a priority scheme relating to recommended respective content segments of a media item. For example, for a media item, the classifying component 130 can classify and the rank component 120 can rank a user's interest in one segment of content within a category as higher than another segment of content within the same category. In another aspect, the classifying component 130 can classify and the rank component 120 can rank content consumer interest in a categorized segment of media content and/or advertisements against one or more categorized segments of media content and/or advertisements from the same or different media items. For example, the classification component can classify a first set of media content frames and the rank component 120 can rank a first set of categorized media content segment frames of a first media item higher or lower than a second set of categorized content segment frames of a second media item.

In an embodiment, advertising component 140 can match, place, and/or price respective advertisements to ranked segments of media content. Advertising is often conventionally presented to a general audience that may include many disinterested viewers and fail to include many interested viewers. System 100 identifies and ranks content of user interest and popular segments of media content that can be used to present advertisements likely to have impact on particular content consumers, relevant to user interest, and/or likely to capture content consumer attention. The advertising component 140 can determine good matches between respective advertisements, media segments, target audience, geography, user demographics, purchasing history, etc. in order to optimize advertising efficacy in connection with provisioning of content. Moreover, the advertising component 140 can facilitate pricing of advertising impressions. For example, a content provider can charge a premium for display or clicking of an advertisement matched to a highly ranked segment as compared to a lowered ranked segment.

Advertising component 140 can match, place and/or price advertisements based at least in part on classifying component 130. In an aspect, classifying component 130 can classify segments of content according to various characters, and the advertising component 140 can match advertisements to the classified content based on similarity and/or relevance of the advertised products or services to the classification. Furthermore, advertising component 140 can match, place and/or price based at least in part on rank component 120. In an aspect, rank component 120 ranks segments of content according to various factors (e.g. number of views) and advertising component 140 can match, place and/or price advertisements to the ranked content based on similarity and/or relevance of the advertised products or services to the classification. Advertising component 140 can access and/or utilize a variety of advertising information including information about how the advertisements are to be rendered (e.g., position, click-through or not, impression time, impression date, size, conversion or not, etc.), content to be associated with the advertisement (e.g., articles, discussion threads, music, video, graphics, search results, web page listings, etc.), form of advertisements such as graphical advertisements, so-called banner advertisements, text only advertisements, audio advertisements, video advertisements, etc.

Additionally, advertising component 140 can effect inventorying of advertisements, storing advertisement information, utilizing historical (e.g. statistical) information regarding advertisements, access and utilize advertisement targeting information (e.g. geo-targeting”), perform cost determination operations, allow advertisers to interface with the component, and contain billing operations. In an embodiment, advertising component 140 can match, place, and/or price respective advertisements to ranked segments of media content in connection with the rank component 120 and/or classified segments of media content in connection with classifying component 130. Advertising component 140 can match, place, and/or price advertised products and/or services based on similarity to content of media segments considering classification of segments of content (based at least in part on classifying component 130). Advertising component 140 can match advertised products or services based on similarity to content of media segments considering classification of segments of content (based at least in part on rank component 120). Advertising component 140 can match, place, and/or price advertised products and/or services based on similarity to content of media segments considering classification (based at least in part on classifying component 130) and rank of segments of content (based at least in part on rank component 120).

In another embodiment, advertising component 140 can match, place and/or price advertisements where the advertisements include information (e.g., embedded information) concerning accounts, campaigns, targeting, etc. An account refers to information for a given advertiser (e.g., a unique email address, a password, billing information, etc.). A campaign refers to one or more groups of one or more advertisements, and may include a start date, an end date, budget information, geo-targeting information, syndication information, etc. For example, a car manufacturer may have one advertising campaign for its automotive line, and a separate advertising campaign for its motorcycle line. The manufacturer's campaign for its automotive line may have one or more advertisement groups, each containing one or more advertisements. Each advertisement group may include a set of keywords, and a maximum cost bid (cost per click-though, cost per conversion, etc.). Alternatively, or in addition, each advertisement group may include an average cost bid (e.g., average cost per click-through, average cost per conversion, etc.). Therefore, a single maximum cost bid and/or a single average cost bid may be associated with one or more keywords. Further, each advertisement group may have one or more advertisements or “creatives” (That is, advertisement content that is ultimately rendered to an end user.).

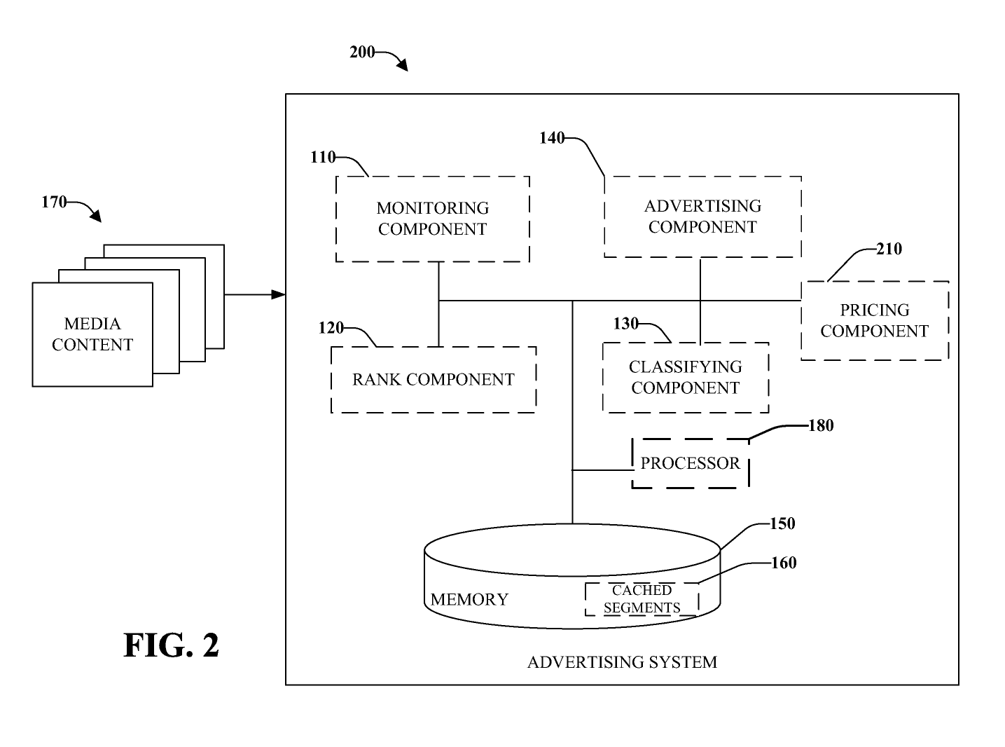

Turning now to FIG. 2, presented is another exemplary non-limiting embodiment of system 200 in accordance with the subject of the disclosure. In an aspect, system 200 facilitates pricing advertisement slots for advertisements to be matched to media segments. System 200 employs pricing component 210 that prices advertisement slots associated with respectively ranked media segments based at least in part on the ranking. The pricing component 210 can price advertising slots matched to highly ranked segments of content at greater prices than advertising slots matched to low ranked segments of content. In an aspect, pricing component 210 can price advertising slots based on any one or more price parameters described herein.

A candidate advertisement can be placed in one or more advertising slots. Advertisers can bid to place their candidate advertisement in an advertising slot matched to a segment of content. An auction component 710 (described herein) can coordinate bidding among advertisers for placements of their advertisements in the one or more available advertising slots. In an aspect, advertisers may bid on one or more price parameters. A price parameter is a factor on which the price of an advertisement slot can be based (as a function of price component 210). In another aspect, advertisers do not bid on an advertisement slot nor a price parameter, but instead advertisers pay a pre-set price as priced by pricing component 210. Examples of a price parameter include, but are not limited to, a cost-per-impression, a maximum cost-per-click, a cost-per-conversion, and a cost per action. In one aspect, advertisers can bid on one or more price parameters related to a particular advertising slot. For instance, a cost-per click bid is a price for an advertisement slot based on the aggregate number of clicks (i.e. by users) received by an advertisement matched to a segment of content. For example, assume that at a given point in time, advertisement slot Z has the following costs-per-click bids from advertisers, respectively: $5.00 per click, $1.50 per click, $1.00 per click, $0.90 per click, and $0.25 per click. The advertiser who bid $5.00 per click is awarded the advertisement slot Z for placement of their candidate advertisement. Other price parameters may be used with the embodiments described herein.

Similarly, a price parameter can be based on a price per impression, which is a price for the number of counts an advertisement loads (also known as an impression) onto a user's screen (i.e. pop-up advertisements). Further, a cost per action is a price parameter based on specified actions linked to an advertisement (i.e. a purchase of an advertised good, submission of an advertised application, subscription to an advertised service, etc.). Another price parameter is a cost-per conversion which is a price based on any number of “conversions” or value related to acquiring a customer (e.g. value of a customer lead, revenue from a sale, value of exposure to a demographic of users, an estimate of percentage of users who an advertisement or keyword make a purchase, etc.)

In another embodiment, pricing component 210 can price an advertisement slot based on normalizing advertisement bids for a specific advertising slot based on different price parameters, This normalization can allow advertisers that want to pay for an advertising slot using different price parameters to compete by bidding on a common basis (the bid values can be normalized to a common basis, such as dollars). Thus pricing component 210 based in part on auction component 710 can award an advertising slot to an advertiser who bids on a cost-per-click basis over an advertiser who bids on the same advertising slot on a cost-per-conversion basis.

Additionally, with respect to price-per-conversion, using conversion rate information may be particularly attractive to advertisers, for it provides a direct way for advertisers to compare their advertising cost to the benefits they obtain from that advertisement. For example, suppose an advertiser (Advertiser W) is able to estimate that approximately 15% of users who see an advertisement for a set of keywords ultimately make a purchase from Advertiser W. And suppose further that Advertiser W can estimate that on average each such purchase resulted in revenue of $50 to Advertiser W. Advertiser W can then determine that the value to it of each advertisement is $7.50 (0.15 multiplied by $50). Advertiser W can use that information to decide how much it is willing to pay for those advertisements, which would presumably be some amount less than $7.50.

Suppose further that Advertiser X is able to estimate that for the same set of keywords, approximately 30% of user who see its advertisement make a purchase from Advertiser X for an average price of $50. The value of the advertisement to Advertiser X is $15 (0.30 multiplied by $50). Therefore, Advertiser X ought to be willing to pay more for its advertisement than Advertiser W would be (e.g., up to $15 rather than up to $7.50). An advertiser, however, may not want to provide system 200 with the conversion information specified above (e.g., revenue generated per number of views). The advertiser may, instead, simply specify the price they are willing to pay for each conversion. Using the example above, Advertiser X may specify a maximum (or average, or other) price per conversion of $15, while Advertiser W may specify a price per conversion of $7.50. System 200 based in part on rank component 120 can then use that information in determining how to rank the advertisements (e.g., Advertiser X's advertisement first, then that of Advertiser W) and how much to charge for those advertisements (i.e. if pricing component 210 is basing price on a pre-set amount or minimum start bid).

The identity of a conversion may vary from case to case and can be determined in a variety of ways. For example, it may be the case that a conversion occurs when a user clicks on an advertisement, is referred to the advertiser's web page, and consummates a purchase there before leaving that web page. Alternatively, a conversion may be defined as a user being shown an advertisement, and making a purchase of the advertiser's web page within seven days. Many other definitions of what constitutes a conversion are possible. Pricing component 210 may price advertisements by numerous other techniques.

In other embodiments, the pricing component 210 adjusts pricing of the advertisement slots based at least in part on advertiser demand. In an aspect, pricing component 210 can determine demand based on any one or more factors such as number of clicks, number of shares, amount of traffic, content consumer loyalty (e.g. to long running shows or consumer won't illegally download), the nature of the content (e.g. drama, comedy) and its affect on content consumer experience (e.g. emotional response), consumption of segments of content (e.g. clips) vs. consumption of content in entirety (e.g. episodes), nature of content, user recommendations of content, subject matter of previously watched content, number of views, barriers to viewing content (e.g. difficult account registration or poor video quality), the demand for both dynamic experiences (e.g. demand for functionality to enhance active experience such as ability to compile and share playlists that can be cued up to a player) vs. inactive experiences.

In another embodiment, pricing component 210 can employ predicting component 506 to predict traffic flow associated with future streaming of media segments and set pricing for the advertising slots based at least in part on the predicted traffic flow. In an aspect, pricing component 210 predicts traffic flow based on a number of factors such as total number of monthly views, total number of unique monthly users, total number of impressions where one advertisement view is one impression (e.g. if a segment of content contains four advertisements there will be four impressions per segment of content view), number of fraudulent clicks, click-through rate (e.g. number of clicks on an advertisement divided by number of impressions), display time of advertisement, and other such factors.

Furthermore, pricing component 210 can price advertisement slots based on any one or more pricing models such as cost per action (e.g. advertiser is charged each time consumer purchases a product or service), cost per acquisition, cost per lead, cost per purchase, cost per click (advertiser is charged per each click on its advertisement), cost per mille (e.g. advertiser is charged per thousand impressions), flat rate (e.g. advertiser pays fixed price to display advertisement for a period of time), hybrid models, combination of multiple models. The price of an advertising slot may also be calculated based on other characteristics as well, such as time of day, location of the user, age or other demographic information associated with the user, or the like.

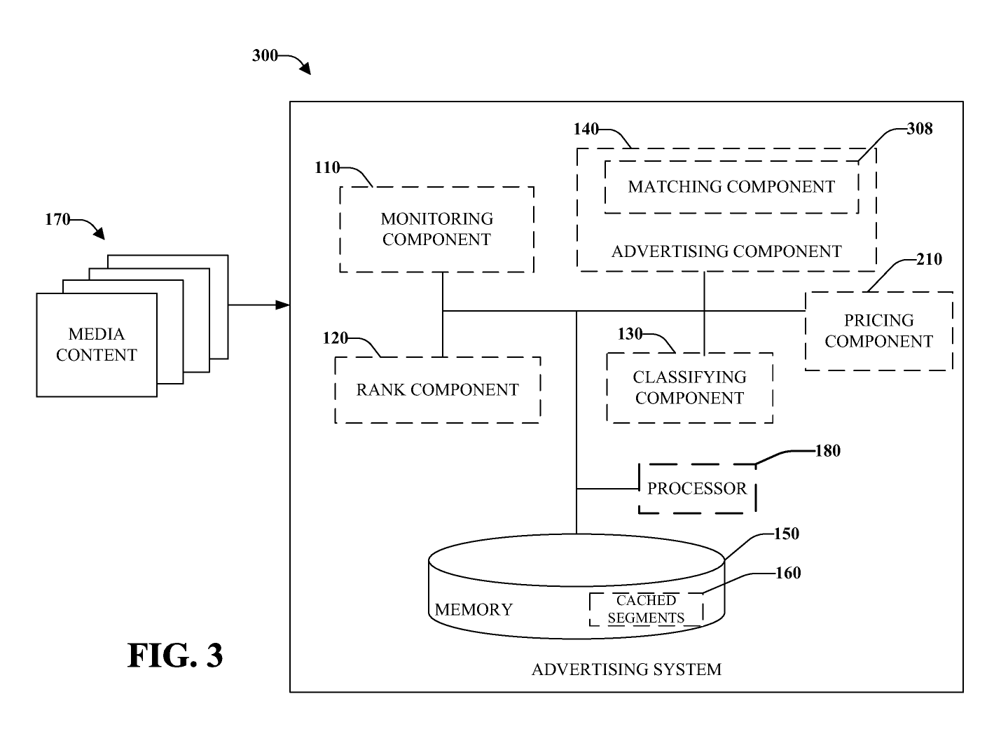

With reference to FIG. 3, presented is another exemplary non-limiting embodiment of a system 300 that facilitates matching an advertisement to segments of media based at least in part on ranking. System 300 includes a matching component 308 employed by advertising component 140. The advertising component 140 employs the matching component 308 to facilitate matching an advertisement to a media segment based at least in part on similarity between content of the media segment and a product or service associated with the advertisement. Content may include the content itself (e.g., video, audio), a category corresponding to the content (e.g., arts, business, computers, arts-movies, arts-music, etc.), part or content type (e.g., text, graphics, video, audio, mixed media, etc.), or attributes of the content (geo-location, age of the content, etc.).

Matching component 308 matches advertisements to the content of media segments by scoring similarity of the content of the media segment to a product or service advertised. In an example, a subject matter of the content that is relevant to the advertised product or service can receive a higher score than a subject matter less relevant to the product or service advertised. For instance, matching component 308 can designate a higher score to a segment of content relating to tourism in Italy with an advertisement for a special price on a flight to Italy, rather than a score for a segment of content relating to an action sequence in South Africa. Also, matching component 308 can match advertisements to the content of media segments by scoring an advertisement (in lieu of or in addition to scoring a segment of content). In another example, matching component 308 can match advertisements to segments of content based on similarity of the content type (e.g., animated advertisement, 3-D advertisement, comedy advertisement, audio-focused advertisement, etc.). For instance, a children's cartoon video may be more similar (higher score segment of content) to an animated advertisement over a cooking segment video (lower score segment of content). Another example occurs where an attribute of the media content or advertised product and/or service may be used to score an advertisement or segment of content higher than another advertisement or segment of content (e.g., geo-location of user consuming the media content). For example, a content consumer downloading a video from Oakland, Calif. would likely take greater interest in an advertisement for tickets to an Oakland-based sport team (e.g. higher score advertisement) rather than an advertisement for tickets to a Cincinnati-based sports team (e.g. lower score advertisement).

In another embodiment, matching component 308 matches respective advertisements to the ranked segments of media. In an aspect, matching component 308 can be configured to match an advertisement to a media segment based at least in part on similarity between context of the media segment and a product or service associated with the advertisement. As described herein, context refers to the surrounding suggestion or expression that a segment of media or advertisement conveys (appeal, tone, perception, meaning, sensation, emotion, etc.). In an aspect, matching component 308 matches based on a score of the similarity between the context of the media segment and the product or service advertised. In an embodiment, matching component 308 may score the similarity between media content and advertisement based on a level of match between a list of keywords associated with a user or segment of media content consumed, and keywords associated with the advertisement. For example, if user consumes media content related to an athletic activity with a keyword in the title being “college football,” a beer advertiser may associate keywords like “beer,” “football,” “college,” “sports,” and “comedy” with an advertisement. Thus the advertisement can be displayed on a search result page displaying the respective segment of media content. Matching component 308 may account for contextual factors including, but are not limited to, genre of content, relevance to user interest, target audience, user demographics, navigation history of user, geography, social interests, and perspectives of a user.

Likewise, matching component 308 may match a segment of content to an advertisement based on a score for similarity of context based at least in part on user interactions associated with keywords, such as through a “tagging” process by which a submitter of media content (i.e. video) or a content consumer assign tags to the program. Matching component 308 based at least in part on advertising component 140 can match advertisements with segments of media content using such tags or keywords. For instance, matching component 308 may match a music video segment tagged by user wherein the artist wears designer sunglasses to an advertisement for a discount at a designer sunglass store. Furthermore, user may identify keywords as inputs for searching, commenting, and labeling segments of media content and the keywords can correlate to advertisements likely to capture the attention of user.

In another embodiment, matching component 308 matches an advertisement to a media segment based at least in part on demographics of users that deem the media segment popular. Demographics of users refers to statistical characteristics of a set of users consuming a segment of media. The statistical characteristics can include, but are not limited to user age, gender, race, employment status, marital status, geo-location information, sexual disposition, and so on. In an aspect, matching component 308 can match an advertisement to a media section consumed by a large set of common users, (e.g. a popular segment) belonging to one or more particular demographic characteristics. For example, when multiple users between the age of 18 and 25 repeatedly view a skateboarding video segment, matching component 308 may match an advertisement catering to adolescent men such as a skateboarding video game. Additionally, matching component 308 can match the advertisement to other same or similar segment of media content wherein users belonging to a particular demographic repeatedly consume content segments

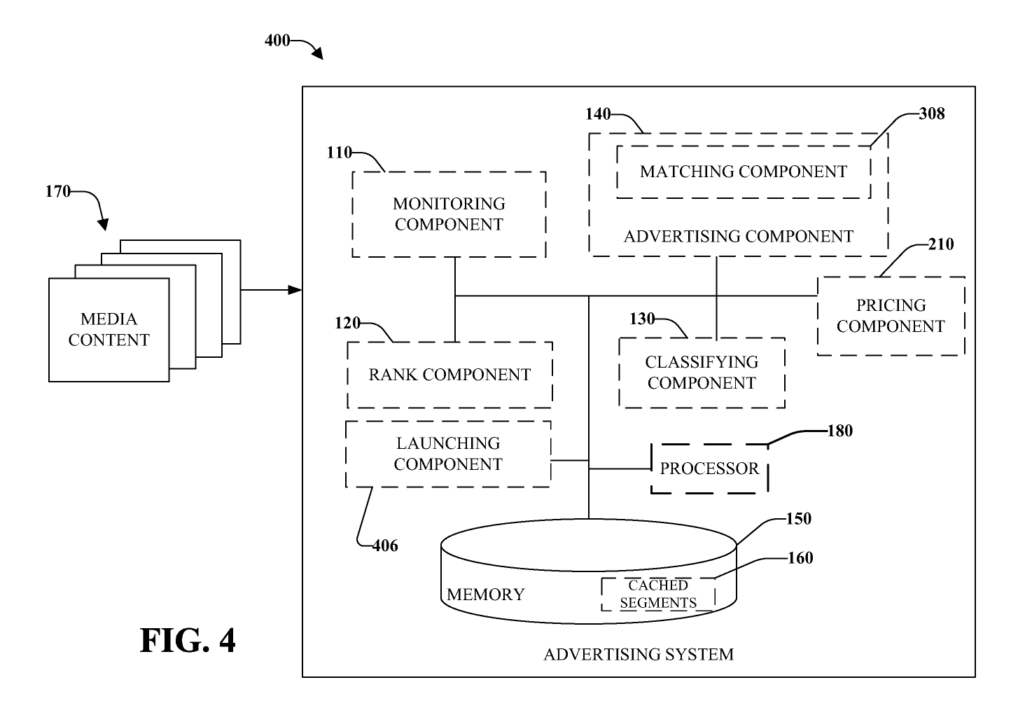

With reference to FIG. 4, presented is another exemplary non-limiting embodiment of a system 400 in accordance with the subject disclosure. In an aspect, system 400 facilitates launching an advertisement. System 400 includes launching component 406 wherein an object within the media segment can be clicked to launch the advertisement. For example if the user then selects an object, such as a retrieved advertising link (e.g., by clicking on an advertising link), a document corresponding to the advertisement may be retrieved and presented to the user.

A “document,” as the term is used herein, include, but is not limited to, any machine-readable and machine-storable work product. A document may include, for example, an e-mail, a web site, a file, a combination of files, one or more files with embedded links to other files, a news group posting, a blog, a web advertisement, etc. In the context of the Internet, a common document is a web page. Web pages often include textual information and may include embedded information (such as meta information, images, hyperlinks, etc.) and/or embedded instructions (such as JavaScript, etc.). A “link,” as the term is used herein, is to be broadly interpreted to include any reference to/from a document from/to another document or another part of the same document. Accordingly, launch component 406 launches a document (e.g. advertisement) when user selects an object (e.g. clicks on an icon) within media content and launches the advertisement for user consumption.

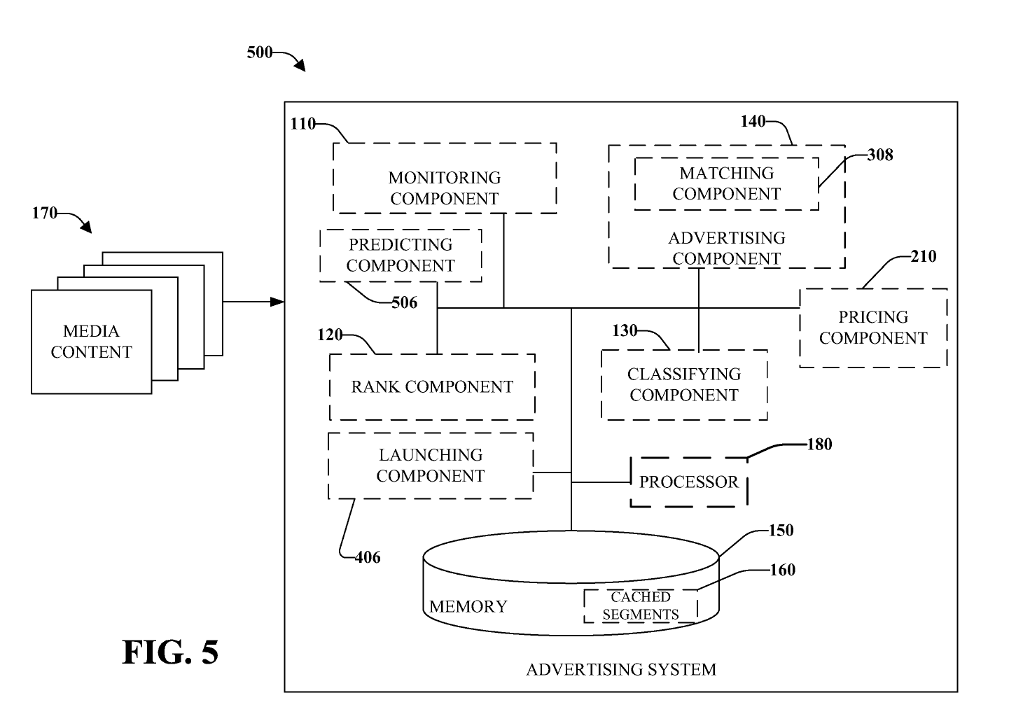

With reference to FIG. 5 presented is another exemplary non-limiting embodiment of a system 500. In an aspect, system 500 employs predicting component 506 that predicts when future demand for a segment of media content will level off or decline. Predicting component 506 may predict future demand by applying any one or more algorithms to predict or anticipate the future demand for a segment of media content. As an aspect, predicting component 506 can predict future demand by considering numerous factors regarding future demand for a segment of media content by one or more users such as trafficking logistics, media programming logistics, content ratings, historical number of viewers, seasonal correlations to number of views, timing correlations to number of views, newness or staleness of media content, individual characteristics of content consumers, availability of segment of content and other such factors relating to demand.

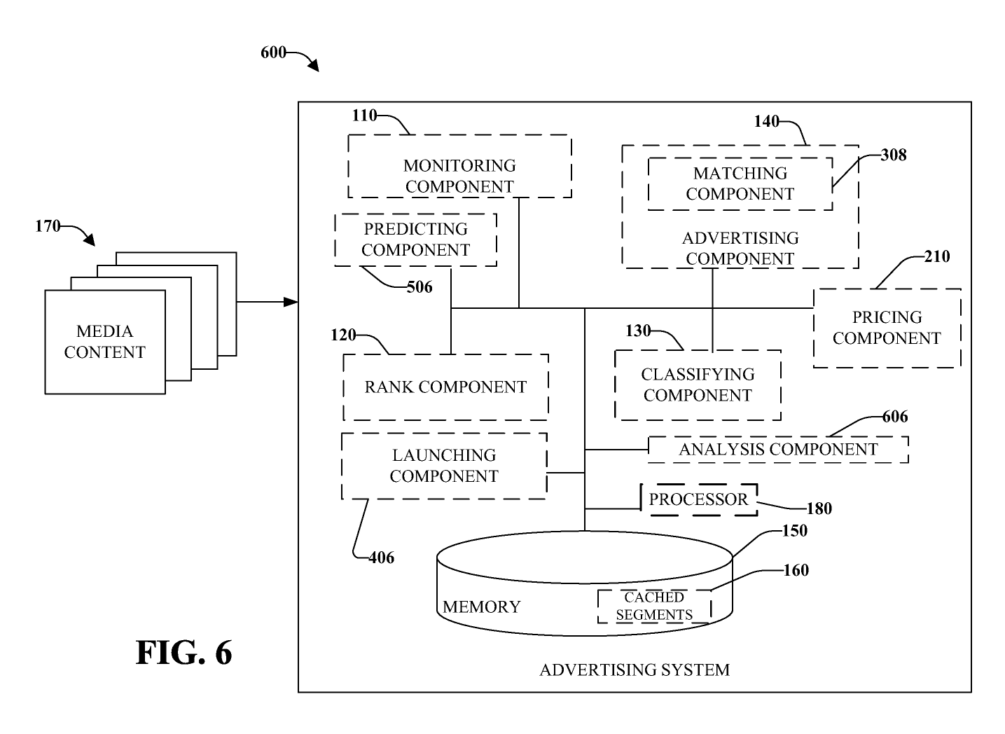

With reference to FIG. 6 presented is another exemplary non-limiting embodiment of system 600. In an aspect, system 600 facilitates analysis of the number of views of an advertising impression and/or segment of media content. System 600 includes analysis component 606 that analyzes number of views of an advertising impression. In an embodiment, system 600 may provide advertising links, to users when they consume segments of content. A user may select (or click) the advertising link, which can cause the user to navigate to a web page belonging to the advertiser associated with the advertising link. This selection of an advertising link by a user is commonly referred to as a “click.”

System 600 employs analysis component 606 to analyze the number of impressions and clicks for a segment of media content and/or an advertisement. For example, analysis component 606 may analyze the number of clicks that an advertising link receives during a given period of time. If the user then selects one of the retrieved advertising links (e.g., by clicking on an advertising link), an advertisement click request may be generated. Analysis component 606 can analyze the number of views of an advertisement and/or segment of media content by aggregating the number of clicks and tracking the number of impressions for purposes of calculating prices to charge for respective advertisements, compiling statistics, gathering data for advertisers and other such purposes. The analysis component 606 may also analyze whether an advertising link that was previously retrieved by an advertisement query request was selected by a specific user. Furthermore, analysis component 606 can analyze browser information, client information, and/or user information may be collected with both the advertisement query request and the advertisement click request.

In another aspect, analysis component 606 analyzes traffic patterns for the media segments and/or advertisement based at least in part on at least one of: user demographics, user preferences, user relevance, content genre, target user, or pre-defined criteria. Information relating to traffic associated with a segment of media content over time may be used to generate (or alter) the score associated with the segment of media. For example, analysis component 606 may monitor the time-varying characteristics of traffic to, or other “use” of, a segment of content by one or more users. A large reduction in traffic may indicate that a segment of media content may be stale (e.g., no longer be updated or may be superseded by another segment of media content).

In one implementation, analysis component 606 can analyze traffic patterns by comparing the average traffic for a segment of content over the last j days (e.g., where j=30) to the average traffic during the month where the segment of content and/or advertisement received the most traffic, optionally adjusted for seasonal changes, or during the last k days (e.g., where k=365). Optionally, analysis component 606 may identify repeating traffic patterns or perhaps a change in traffic patterns over time. It may be discovered that there are periods when a segment of content is more or less popular (i.e., has more or less traffic), such as during the summer months, on weekends, or during some other seasonal time period. By analyzing and identifying repeating traffic patterns or changes in traffic patterns, analysis component 606 can employ rank component 120 to rank advertisements segments based in part on a score to account for traffic patterns and/or other information analyzed from analysis component 606.

In an aspect, analysis component 606 analyzes traffic patterns for the media segments based at least in part on at least one of user demographics, user preferences, user relevance, content genre, target user, or pre-defined criteria. For example, an advertiser may produce a commercial that is targeted to a particular user group or to reach a particular group of viewers. For example, the advertiser may assign a set of fixed attribute values, such as household income and age, to a commercial that demographically define a group of viewers. Also, an advertiser may select a program or group of programs during which a promotion is to air. For example, a pharmaceutical company may set a commercials profile so that its drug advertisement airs only during news programming, while an advertiser of a convertible car may target its commercial to advertisement slots within music programs or programs associated with a younger demographic.

In accordance with these criteria, analysis component 606 can analyze an advertisement and/or segment of content to consider any number of factors, including but not limited to, audience relating to a segment of content, user age, user gender, user locations, different characteristics of content, user contexts, user interests, and perspectives of a user. Examples of other factors that may be employed in analyzing a segment of media content can include the type of video article, time period (e.g., time of day, or day of the week), user location (e.g., to match (by employing matching component 308) video articles broadcast in close proximity to the user), selection of the video article by previous users (e.g., users querying for the same or similar terms), and whether the video article is available for playback (e.g., video articles available for playback have greater user interest). The analysis component 606 can also analyze traffic patterns based on user preferences (e.g., media format, media quality, rendering device capabilities, media encoding, video or audio resolution . . . ).

User preferences can be basic information about characteristics, attributes or categorization of content that respective users prefer to consume. User preference may include format of content, type of content interface preferred, display resolution, video quality, audio quality, bit rate, number of frames per second, aspect ratio, scaling formats, audio output options, display options, and other preferential information. Furthermore, user preference can factor determined user viewing intent by filtering content according to user preference. For example, a user of video content may prefer to view only videos in high definition (HD) format; thus analysis component 606 can analyze and filter out media segments that are not in HD format, or alternatively up-weight ranking of HD formatted content over non-HD formatted media.

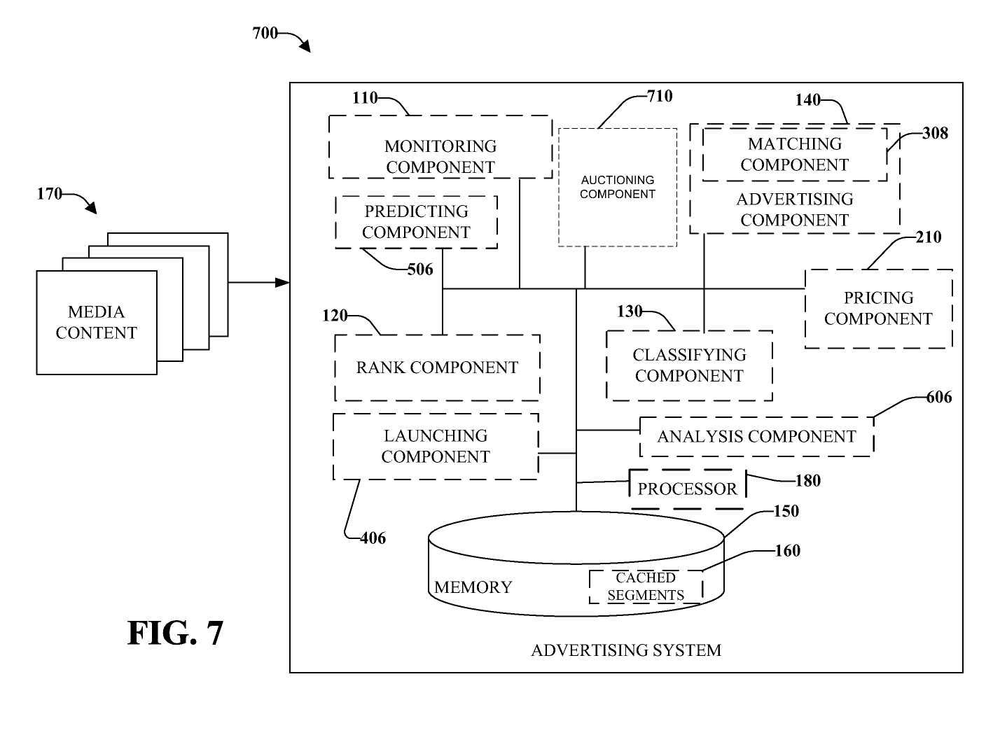

With reference to FIG. 7 presented is another exemplary non-limiting embodiment of a system 700. In an aspect, system 700 facilitates analysis of the number of views of an advertising impression. System 700 includes auction component 710 that sets and receives bids for advertising slots associated with the ranked segments. The system 700 based at least in part on auction component 710 which can employ matching component 308 to match candidate advertisements to match to segments of media content based on advertiser bids, advertiser budgets, and/or any quality metrics that have been collected (e.g. viewer actions, impressions, . . . ) For example, advertisements can be placed within advertisement slots according to a computer-implemented auction. In one aspect, auction component 710 can set and receive bids for advertising slots based on a Vickrey-style auction in which each advertiser pays the bid of the next highest advertisement. Other auction processes can also be used, e.g., setting an advertiser bid equal to the estimated number of viewer impressions multiplied by the price an advertiser has offered to pay for each impression, etc.

Auction component 710 can set and receive bids for advertising slots by making use of one or more different bidding types. For example, the bidding types can be cost per airing, a cost per impression, a cost per full viewing of the advertisement, a cost per partial viewing of the advertisement, etc. Other types of costs per action bids can also be used, such as a cost per network airing (e.g., $5.00 per 1000 impressions on a first network, $6.00 per 1000 impressions on a second network), cost per action scaled by the time of day, etc. An auction process can, for example, support advertisements with different or even multiple (hybrid) bidding types. Auction component 710 can set and receive bids for advertising slots so advertisers may provide their advertisements based on preferred factors (duration of time for advertisement slot, etc.).

In an aspect, auction component 710 can set and receive bids for advertising slots based on a sliding scale. For instance an advertiser can bid on an advertising slot based on price per impression by a percentage of targeted. Thus advertiser can bid on an advertisement slot at a price per impression to a demographic of users within the age of 18 to 25 wherein the percentage of total impressions received from the 18 to 25 age demographic is set at a different bid price than impressions not received from such age demographic. The bids can be based on various thresholds (e.g. impressions from 25% of viewers age 18 to 25 cost at X bid price, impressions from 50% of viewers age 28 to 25 cost Y bid price) and the thresholds can fluctuate over the course of the advertisement campaign.

The advertising provider can thereafter provide a status to the advertisement system 700 regarding when the advertisement aired. The provider can also, for example, provide anonymous impression data related to viewing devices. Examples of viewing devices include set top boxes, digital video recorders and tuners, and other television processing devices that facilitate the viewing of the television signal on a television device. For example, logs related to viewing device 164 activity, e.g., set top box logs, can be anonymous to remove personal information related to viewing activities and provided to the advertisement system 700. An auction model can create pricing efficiencies for both buyers and sellers of advertising. Advertisers can benefit from efficiencies by paying only for delivered impressions, or delivered actions, or other types of measurable events. Advertisers can also benefit form receiving the information the advertisers need to continually enhance the effectiveness of the advertiser's advertisements. In an aspect, auction component 710 sets and receives bids for advertising slots by making use of one or more auctions to allow advertisers seeking different thresholds of exposure (1,000, 10,000, 100,000, and/or 1,000,000 views/impressions) to participate in respective auctions that match their thresholds. For example, auction component 710 can set and receive bids in one auction for advertising slots to place advertisements for a period of time lasting 100,000 views and a different auction to set and receive bids for advertising slots that accommodate advertisements for a period lasting 10,000 views.

In one embodiment, a client device/component/software notifies users of the types of information that are stored in respective applications logs and transmitted to a server, and provides the user the opportunity to opt-out of having such information collected and/or shared with the server.

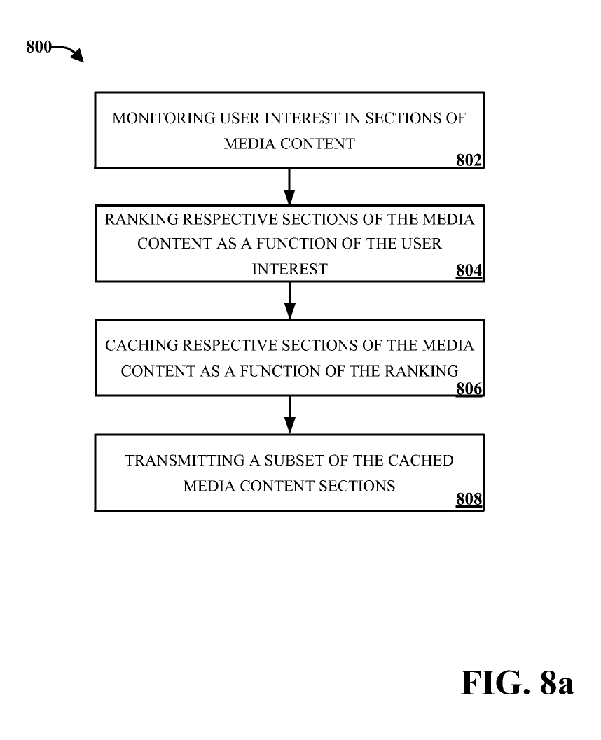

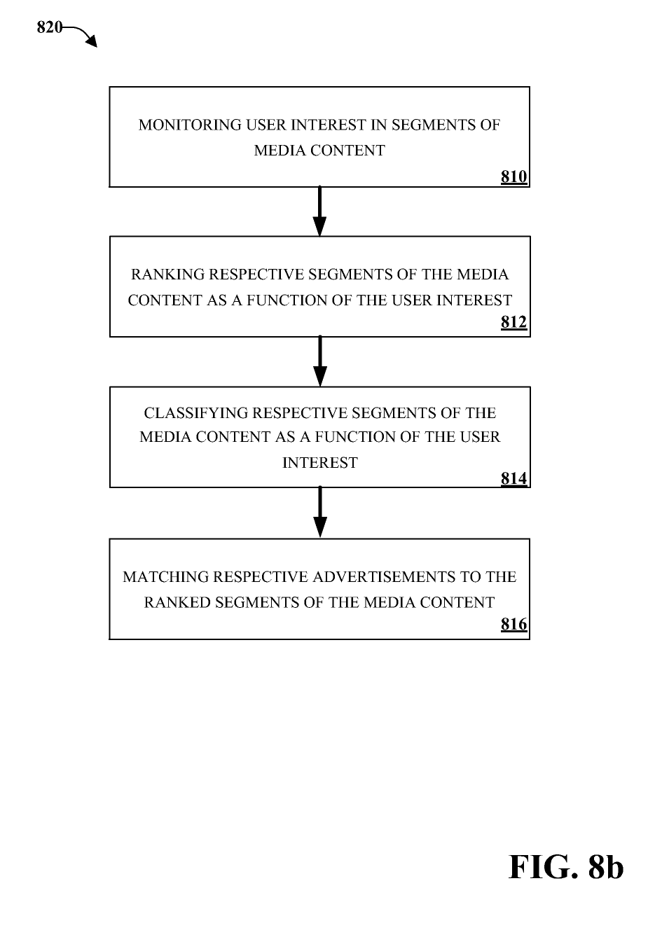

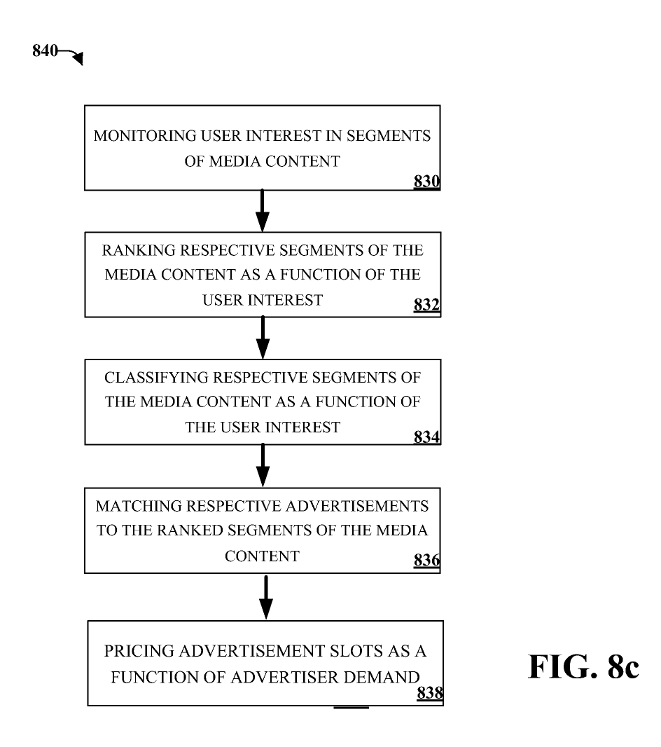

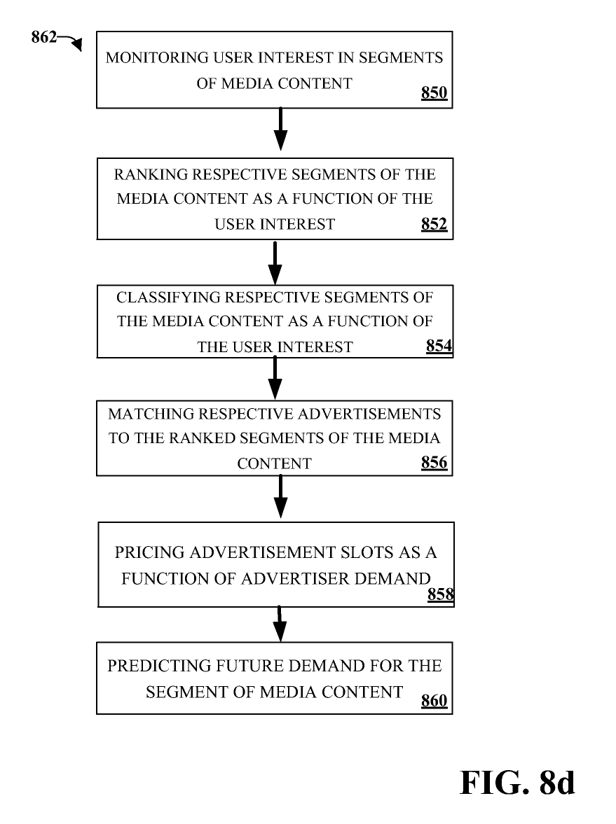

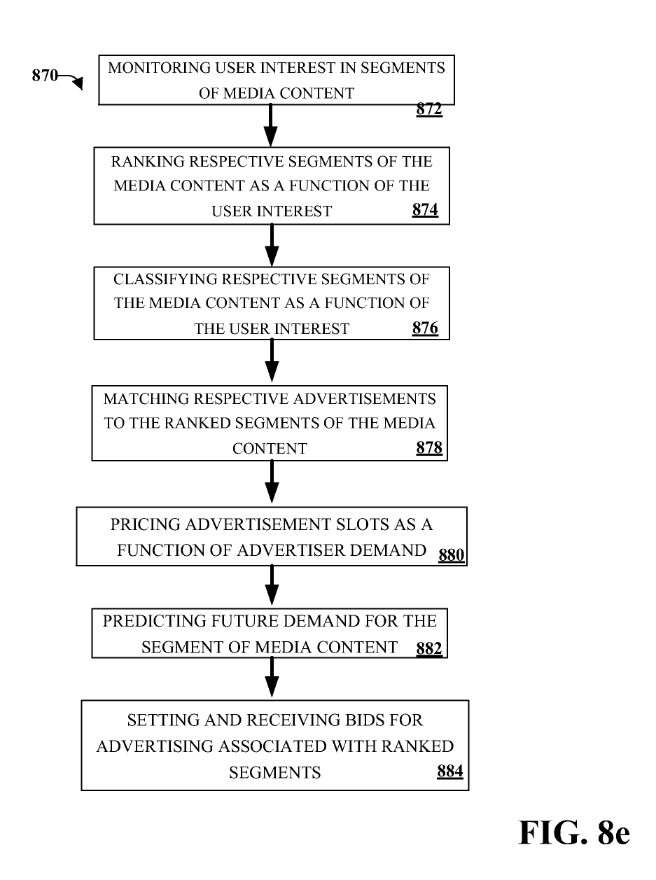

FIGS. 8a-8e illustrate methodologies or flow diagrams in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices.

Referring now to FIG. 8a, presented is a flow diagram of an example methodology 800 of a system (or other such embodiments systems described in this disclosure). In an aspect, exemplary methodology 800 of a system is stored in a memory and utilizes a processor to execute computer executable instructions to perform functions. At 802, content consumer interest in segments of media content is monitored (e.g., using a monitoring component). The monitoring can include for example level of user traffic and focus directed to respective segments of media. At 804, respective segments of media items are ranked based at least in part on content consumer interest (e.g., using a ranking component). The ranking can be based on level of user traffic or focus directed to respective media content segments. The ranking can also be a function of content consumer demographics. Accordingly, a same media item segment can have different values with respect to different sets of content consumers. At 806, respective segments of media content are cached based at least in part on rank (e.g., using a caching component). Highly ranked media segments are cached to provide quick access to large sets of content consumers. At 808, respective segments of the cached media items are transmitted to respective content consumers (e.g., using an advertising component).

Referring now to FIG. 8b, presented is a flow diagram of an example application of systems disclosed in this description accordance with an embodiment. In an aspect, exemplary methodology 820 of a system is stored in a memory and utilizes a processor to execute computer executable instructions to perform functions. At 810, user interest in segments of media content is monitored (e.g., using monitoring component 110). The monitoring can include for example level of user traffic and focus directed to respective segments of media. At 812, respective segments of media items are ranked (e.g., using rank component 120) based at least in part on content consumer interest. The ranking can be based on level of user traffic or focus directed to respective media content segments. Accordingly, a same media item segment can have different values with respect to different sets of content consumers. At 814, respective segments of media content are classified (e.g., using classifying component 130) based at least in part on user interest. Respective segments of media items are classified to categorize the ranked segments in an orderly manner. At, 816 classified and ranked segments are matched (e.g., using advertising component 140) to respective advertisements.

Referring now to FIG. 8c, presented is a flow diagram of an example application of systems disclosed in this description accordance with an embodiment. In an aspect, exemplary methodology 840 of a system is stored in a memory and utilizes a processor to execute computer executable instructions to perform functions. At 830, user interest in segments of media content is monitored (e.g., using monitoring component 110). At 832, respective segments of media items are ranked (e.g., using rank component 120) based at least in part on content consumer interest. At 834, respective segments of media content are classified (e.g., using classifying component 130) based at least in part on user interest. At, 836 classified and ranked segments are matched (e.g., using advertising component 140) to respective advertisements. At 838, advertisement slots are priced (e.g. using pricing component 210) based at least in part on advertiser demand. Advertisement slots can also be priced in accordance with respectively ranked media segments based at least in part on the ranking.

Referring now to FIG. 8d, presented is a flow diagram of an example application of systems disclosed in this description accordance with an embodiment. In an aspect, exemplary methodology 862 of a system is stored in a memory and utilizes a processor to execute computer executable instructions to perform functions. At 850, user interest in segments of media content is monitored (e.g., using monitoring component 110). At 852, respective segments of media items are ranked (e.g., using rank component 120) based at least in part on content consumer interest. At 844, respective segments of media content are classified (e.g., using classifying component 130) based at least in part on user interest. At, 856 classified and ranked segments are matched (e.g., using advertising component 140) to respective advertisements. At 858, advertisement slots are priced (e.g. using pricing component 210) based at least in part on advertiser demand. At 860, future demand for segments of ranked media content is predicted (e.g. using predicting component 506). The demand predictions can include levels of increases and decreases in demand for segments of content over period's time.

Referring now to FIG. 8e, presented is a flow diagram of an example application of systems disclosed in this description accordance with an embodiment. In an aspect, exemplary methodology 870 of a system is stored in a memory and utilizes a processor to execute computer executable instructions to perform functions. At 872, user interest in segments of media content is monitored (e.g., using monitoring component 110). At 874, respective segments of media items are ranked (e.g., using rank component 120) based at least in part on content consumer interest. At 876, respective segments of media content are classified (e.g., using classifying component 130) based at least in part on user interest. At, 878 classified and ranked segments are matched (e.g., using advertising component 140) to respective advertisements. At 880, advertisement slots are priced (e.g. using pricing component 210) based at least in part on advertiser demand. At 882, future demand for segments of ranked media content is predicted (e.g. using predicting component 506). At 884, the system can set and receive bids (e.g. using auctioning component 710) for advertisement slots associated with ranked segments. The setting and receiving of bids allows for a virtual market place to facilitate efficient selling, buying and pricing of advertisement slots associated with ranked segments.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described in this disclosure. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

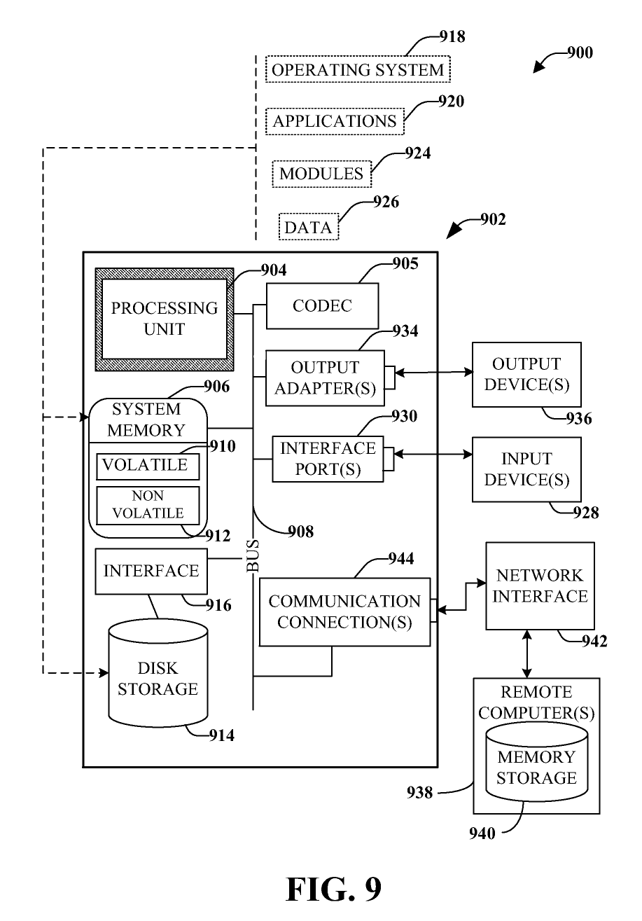

With reference to FIG. 9, a suitable environment 900 for implementing various aspects of the claimed subject matter includes a computer 902. The computer 902 includes a processing unit 904, a system memory 906, a codec 905, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 906 includes volatile memory 910 and non-volatile memory 912. The basic input/output system (BIOS), containing the basic routines to transfer information between elements within the computer 902, such as during start-up, is stored in non-volatile memory 912. In addition, according to present innovations, codec 905 may include at least one of an encoder or decoder, wherein the at least one of an encoder or decoder may consist of hardware, a combination of hardware and software, or software. Although, codec 905 is depicted as a separate component, codec 905 may be contained within non-volatile memory 912. By way of illustration, and not limitation, non-volatile memory 912 can include read only memory (ROM), programmable ROM (PROM), electrically programmable ROM (EPROM), electrically erasable programmable ROM (EEPROM), or flash memory. Volatile memory 910 includes random access memory (RAM), which acts as external cache memory. According to present aspects, the volatile memory may store the write operation retry logic (not shown in FIG. 9) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 902 may also include removable/non-removable, volatile/non-volatile computer storage medium. FIG. 9 illustrates, for example, disk storage 914. Disk storage 914 includes, but is not limited to, devices like a magnetic disk drive, solid state disk (SSD) floppy disk drive, tape drive, Jaz drive, Zip drive, LS-70 drive, flash memory card, or memory stick. In addition, disk storage 914 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 914 to the system bus 908, a removable or non-removable interface is typically used, such as interface 916.

It is to be appreciated that FIG. 9 describes software that acts as an intermediary between users and the basic computer resources described in the suitable operating environment 900. Such software includes an operating system 918. Operating system 918, which can be stored on disk storage 914, acts to control and allocate resources of the computer system 902. Applications 920 take advantage of the management of resources by operating system 718 through program modules 924, and program data 926, such as the boot/shutdown transaction table and the like, stored either in system memory 906 or on disk storage 914. It is to be appreciated that the claimed subject matter can be implemented with various operating systems or combinations of operating systems.

A user enters commands or information into the computer 902 through input device(s) 928. Input devices 928 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 904 through the system bus 908 via interface port(s) 930. Interface port(s) 930 include, for example, a serial port, a parallel port, a game port, and a universal serial bus (USB). Output device(s) 936 use some of the same type of ports as input device(s) 928. Thus, for example, a USB port may be used to provide input to computer 902, and to output information from computer 902 to an output device 936. Output adapter 934 is provided to illustrate that there are some output devices 936 like monitors, speakers, and printers, among other output devices 936, which require special adapters. The output adapters 934 include, by way of illustration and not limitation, video and sound cards that provide a means of connection between the output device 936 and the system bus 908. It should be noted that other devices and/or systems of devices provide both input and output capabilities such as remote computer(s) 938.

Computer 902 can operate in a networked environment using logical connections to one or more remote computers, such as remote computer(s) 938. The remote computer(s) 938 can be a personal computer, a server, a router, a network PC, a workstation, a microprocessor based appliance, a peer device, a smart phone, a tablet, or other network node, and typically includes many of the elements described relative to computer 902. For purposes of brevity, only a memory storage device 940 is illustrated with remote computer(s) 938. Remote computer(s) 938 is logically connected to computer 902 through a network interface 942 and then connected via communication connection(s) 944. Network interface 942 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 944 refers to the hardware/software employed to connect the network interface 942 to the bus 908. While communication connection 944 is shown for illustrative clarity inside computer 902, it can also be external to computer 902. The hardware/software necessary for connection to the network interface 942 includes, for exemplary purposes only, internal and external technologies such as, modems including regular telephone grade modems, cable modems and DSL modems, ISDN adapters, and wired and wireless Ethernet cards, hubs, and routers.

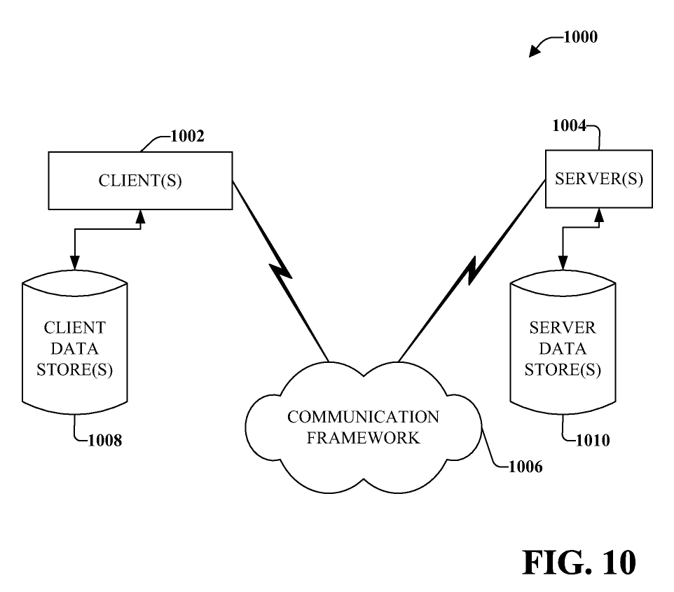

Referring now to FIG. 10, there is illustrated a schematic block diagram of a computing environment 1000 in accordance with this disclosure. The system 1000 includes one or more client(s) 1002 (e.g., laptops, smart phones, PDAs, media players, computers, portable electronic devices, tablets, and the like). The client(s) 1002 can be hardware and/or software (e.g., threads, processes, computing devices). The system 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. One possible communication between a client 1002 and a server 1004 can be in the form of a data packet transmitted between two or more computer processes wherein the data packet may include video data. The data packet can include a metadata, such as associated contextual information for example. The system 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 include or are operatively connected to one or more client data store(s) 1008 that can be employed to store information local to the client(s) 1002 (e.g., associated contextual information). Similarly, the server(s) 1004 are operatively include or are operatively connected to one or more server data store(s) 1010 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated, that a client 1002 can also transfer uncompressed file to a server 1004 and server 1004 can compress the file in accordance with the disclosed subject matter. Likewise, server 1004 can encode video information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

1. A system, comprising:
a memory to store data associated with segments of media content; and
a processor, operatively coupled to the memory, to:
monitor interactions of a user device with the segments of the media content and generate user interest data based on the monitored interactions of the user device;
determine a classification for respective segments of the media content based at least in part on the user interest data;
match respective advertisements to the respective segments of the media content in view of a similarity between the respective advertisements and the classification for the respective segments;
set prices for advertising slots to matched advertisements based at least in part on predicted network traffic flows associated with the respective segments; and
adjust the prices for the advertising slots based on a number of the users associated with the classification of the respective segment meeting a threshold level.

2. (canceled)

3. The system of claim 1, wherein the processor further to match an advertisement to a media segment based at least in part on similarity between content of the media segment and a product or service associated with the advertisement.

4. The system of claim 1, wherein the processor further to match an advertisement to a media segment based at least in part on similarity between context of the media segment and a product or service associated with the advertisement.

5. The system of claim 1, wherein an object within the media segment can be clicked to launch the advertisement.

6. The system of claim 1, wherein the processor further to match an advertisement to a media segment based at least in part on the number of the users that deem the media segment popular.

7. The system of claim 1, wherein the processor further to predict quantities of future traffic associated with respective segments of media content.

8. The system of claim 1, wherein the processor further to analyze a number of views of an advertising impression.

9. The system of claim 1, wherein the processor further to initiate bids for advertising slots to presently matched advertisements, the advertising slots being associated with an advertiser.

10. The system of claim 9, wherein the processor further to adjust pricing of the advertisement slots based at least in part on a classification for the advertisement slots set by the advertiser corresponding to the classification for the respective segments.

11. (canceled)

12. The system of claim 2, wherein the processor further to predict when future demand for the segment of media content will level off or decline.

13. The system of claim 8, wherein the processor further to analyze traffic patterns for the media segments based at least in part on at least one of: user preferences, user relevance, content genre, target user, or pre-defined criteria.

14. A method, comprising:
monitoring, using a processing device, interactions of a user device with segments of media content stored in memory;
generating, using the processing device, user interest data based on the monitoring of the interactions of the user device;
determining, by the processing device, a classification for respective segments of the media content based at least in part on the user interest data;
matching, by the processing device, respective advertisements to the segments of the media content in view of a similarity between the respective advertisements and the classification for the respective segments;
pricing, by the processing device, advertising slots to matched advertisements based at least in part on predicted network traffic flows associated with the respective segments; and
adjust the prices for the advertising slots based on a number of the users associated with the classification of the respective segment meeting a threshold level.

15. (canceled)

16. The method of claim 14, comprising matching an advertisement to a media segment based at least in part on similarity between content of the media segment and a product or service associated with the advertisement.

17. The method of claim 14, comprising matching an advertisement to a media segment based at least in part on similarity between context of the media segment and a product or service associated with the advertisement.

18. The method of claim 14, comprising enabling an object within the media segment to be clicked to launch the advertisement.

19. The method of claim 14, comprising matching an advertisement to a media segment based at least in part on a classification of users that deem the media segment popular.

20. The method of claim 14, comprising predicting quantities of future traffic associated with respective segments of media content.

21. The method of claim 14, comprising analyzing number of views of an advertising impression.

22. The method of claim 14, comprising initiating auction bids for advertising slots to present matched advertisements, the advertising slots being associated with an advertiser.

23. The method of claim 22, comprising adjusting pricing of the advertisement slots based at least in part on a classification for the advertisement slots set by the advertiser corresponding to the classification for the respective segments.

24. (canceled)

25. The method of claim 15, comprising predicting when future demand for the segment of media content will level off or decline.

26. (canceled)

27. A non-transitory computer readable medium having instructions, that when executed by a computing device cause the computing device to:
monitor interactions of a user device with segments of media content;
generate user interest data for respective segments of the media content based at least in part on the monitored interactions of the user device;
determine a classification for the respective segments of the media content based at least in part on the user interest data;
match respective advertisements to the segments of the media content in view of a similarity between the respective advertisements and the classification for the respective segments; and
price advertisement slots associated with presently matched advertisements based at least in part on predicted network traffic flows associated with the respective segments;
adjust the prices for the advertising slots based on a number of the users associated with the classification of the respective segment meeting a threshold level.

28. the method of claim 1, wherein the predicted network traffic flows comprises predicting adverting traffic flows based on a rate at which advertisements associated with the respective segments are updated.

29. The method of claim 1, wherein the predicted network traffic flows comprises predicting future data streaming rates of content associated with the respective segments.

30. The system of claim 1, wherein the number of the users associated with the classification meets a determined percentage of the threshold level.
